(19) United States
(12) Patent Application Publication
(10) Pub. No.: US 2009/0284659 A1
(43) Pub. Date: Nov. 19, 2009

(54) MONITOR WITH MULTIPLE VIDEO INPUTS AND ONE VIDEO OUTPUT

(75) Inventor: Yao-Wen CHU, La Palma, CA (US)

Correspondence Address: QUINTERO LAW OFFICE, PC, 2210 MAIN STREET, SUITE 200, SANTA MONICA, CA, 90405, US

(73) Assignee: TATUNG COMPANY OF AMERICA, INC., Long Beach, CA (US)

(21) Appl. No.: 12/120,199

(22) Filed: May 13, 2008

(51) Int. Cl. H04N 9/74; H04N 5/66; H04N 3/14

(52) U.S. Cl. 348/588; 348/739; 348/790; 348/E05.001

(57) ABSTRACT

Monitors with multiple video inputs and one video output are provided. The monitor comprises an output connector and a processor. The processor receives video signals from a plurality of video sources, and combines the video signals to generate a composite video signal. The processor outputs the composite video signal via the output connector.

### BACKGROUND OF THE INVENTION

1. Field of the Invention

The disclosure relates generally to monitors, and, more particularly to monitors with multiple video inputs and one video output.

2. Description of the Related Art

Monitors for surveillance application are widely used. A monitor usually has a video input, and has a loop-through output. For example, video signals input to a monitor can be output to another monitor or a recording device. Conventionally, the monitor only directly passes the video signals from the original source to other devices.

Generally, conventional monitors cannot receive multiple video inputs, and simultaneously display the video inputs in a screen. Even if a monitor can receive and display multiple video inputs, the video inputs cannot be output to another monitor for display or a recording device for recording.

### BRIEF SUMMARY OF THE INVENTION

Monitors with multiple video inputs and one video output are provided.

An embodiment of a monitor comprises an output connector and a processor. The processor receives video signals from a plurality of video sources, and combines the video signals to generate a composite video signal. The processor outputs the composite video signal via the output connector.

An embodiment of an LCD monitor comprises an output connector and a processor. The processor receives video signals from a first video source and a second video resource, and combines the video signals from the first and second video sources to generate a composite video signal. The processor outputs the composite video signal via the output connector.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a monitor with multiple video inputs and one video output;

FIG. 2 is a schematic diagram illustrating an embodiment of operations of a monitor with multiple video inputs and one video output;

FIGS. 3A and 3B are examples of composite video signals in a POP mode; and

FIGS. 4A and 4B are examples of composite video signals in a PIP mode.

### DETAILED DESCRIPTION OF THE INVENTION

Monitors with multiple video inputs and one video output are provided.

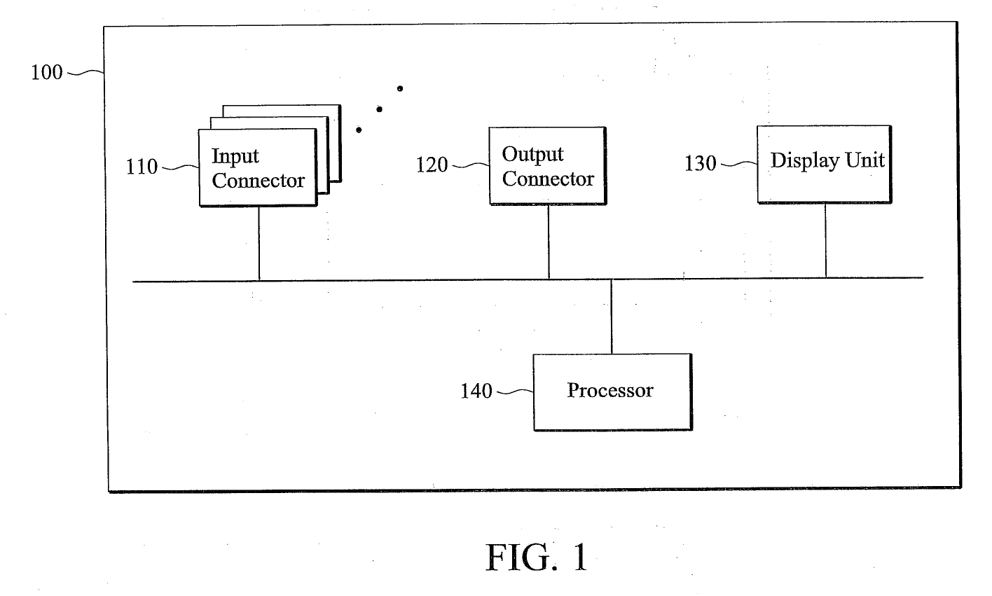

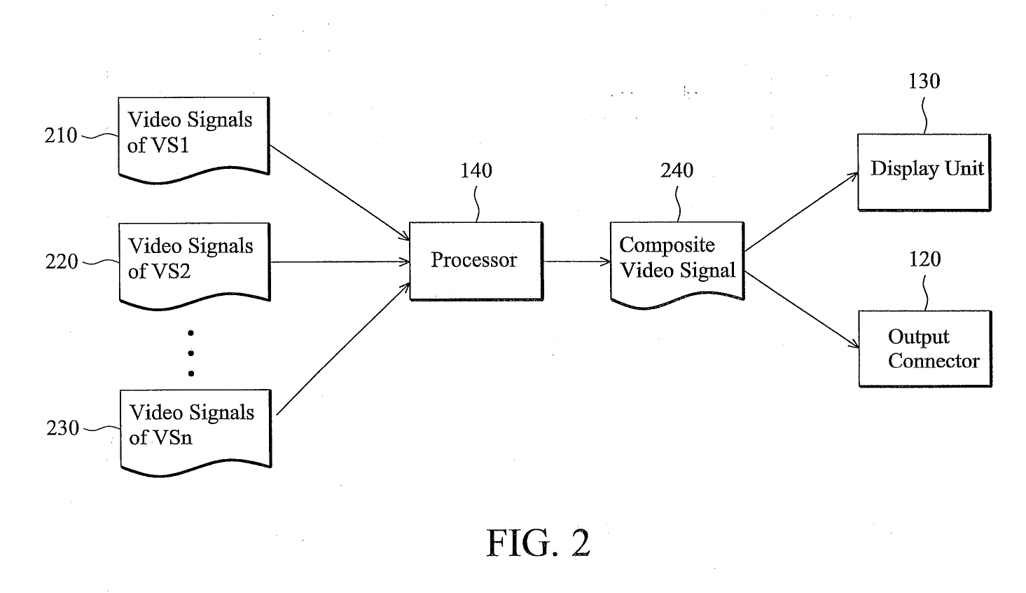

FIG. 1 is a schematic diagram illustrating an embodiment of a monitor with multiple video inputs and one video output. FIG. 2 is a schematic diagram illustrating an embodiment of operations of a monitor with multiple video inputs and one video output.

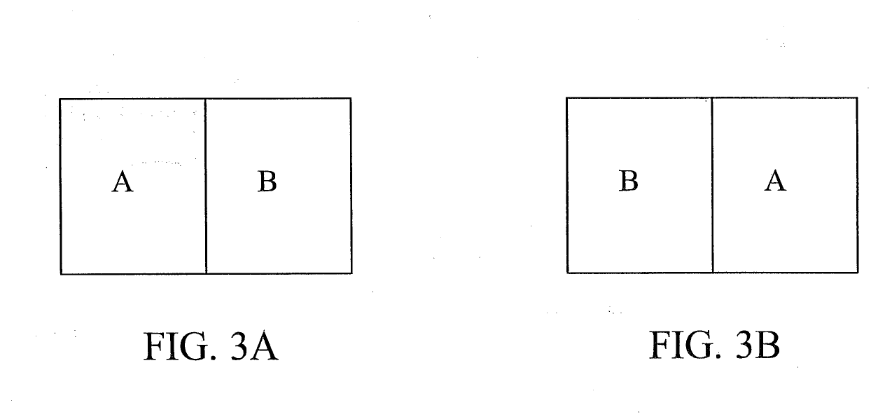

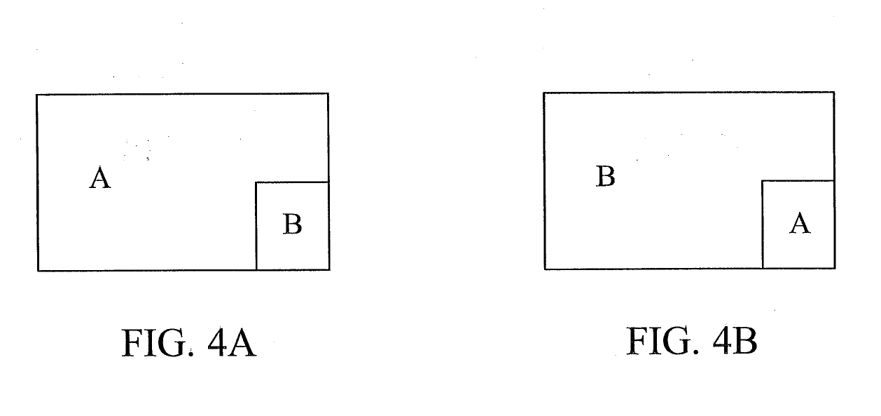

The monitor with multiple video inputs and one video output 100 comprises a plurality of input connectors 110, an output connector 120, a display unit 130, and a processor 140. Each of the input connectors 110 can be connected to a video source (VS), such as a monitor, a camera, or a recording device. The processor 140 receives video signals 210, 220 and 230 from a plurality of video sources (VS1, VS2, . . . , VSn) via the input connectors 110. It is understood that, in some embodiments, the monitor 100 may be a video source, and can provide video signals in addition to the video signals received via the input connectors 110. For example, the monitor 100 is equipped with at least one camera to capture video signals. The processor 140 combines the video signals to generate a composite video signal 240. The processor 140 further comprises a configuration (not shown) recording a display mode such as a PIP (Picture-In-Picture) mode or a POP (Picture-Outside-Picture) mode, and/or the positions for the video signals of the respective video sources to be displayed in the display unit 130. The processor 140 will generate and display the composite video signal 240 according to the configuration. Video signals (pictures A and B) from two video sources, for example, the composite video signals comprising pictures A and B in the POP mode, are shown in FIG. 3A and FIG. 3B, and the composite video signals comprising pictures A and B in the PIP mode are shown in FIG. 4A and FIG. 4B. It is understood that, the display mode and composition manner are not limited thereto. Any kind of format which can display multiple pictures in one screen can be used in the application.

The composite video signal 240 is provided to the display unit 130 such as an LCD panel for display, such that the video signals from the video sources can be simultaneously displayed. The composite video signal 240 is further provided to the output connector 120 for output to another monitor for display, or a recording device for recording. In some embodiments, the output connector 120 may be a BNC (Bayonet Neill-Concelman) connector. It is noted that the format of the composite video signal with the BNC connector is currently the most popular video signal transfer format, especially for distances up to 1000 ft. However, all video formats are possible to be applied in the application and can achieve the same purpose. During display of the composite video signal 240, the same content comprising the video signals from the video sources can be seen on the monitor receiving the composite video signal 240.

Therefore, in the application, the composite video signal comprising video signals of multiple video sources can be simultaneously displayed, and output for secondary monitoring or recording.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A monitor, comprising:
an output connector; and
a processor receiving video signals from a plurality of video sources, combining the video signals to generate a composite video signal, and outputting the composite video signal via the output connector.

2. The monitor of claim 1, wherein the video sources comprise at least one camera, or at least one recoding device.

3. The monitor of claim 2, further comprising a display unit, wherein the processor further simultaneously displays the video signals from the respective video sources in the display unit.

4. The monitor of claim 3, wherein the processor further receives a configuration, and simultaneously displays the video signals from the respective video sources in the display unit according to the configuration, wherein the configuration comprises a display mode comprising a PIP (Picture-In-Picture) mode or a POP (Picture-Outside-Picture) mode.

5. The monitor of claim 3, wherein the processor further receives a configuration recording the positions for the video signals of the respective video sources to be displayed in the display unit, and simultaneously displays the video signals from the respective video sources in the display unit according to the configuration.

6. The monitor of claim 1, wherein the output connector comprises a BNC (Bayonet Neill-Concelman) connector.

7. The monitor of claim 1, wherein the composite video signal output from the output connector is received and recorded by a recording device.

8. The monitor of claim 1, wherein the composite video signal output from the output connector is received by a second monitor for display.

9. The monitor of claim 3, wherein the display unit comprises an LCD panel.

10. The monitor of claim 1, further comprising a plurality of input connectors, each receiving the video signals from one of the video sources.

11. An LCD monitor, comprising:
an output connector; and
a processor receiving video signals from a first video source and a second video sources, combining the video signals from the first video source and second video source to generate a composite video signal, and outputting the composite video signal via the output connector.

12. The LCD monitor of claim 11, further comprising an LCD panel, wherein the processor further simultaneously displays the video signals from the first and second video sources in the LCD panel in a PIP (Picture-In-Picture) mode or a POP (Picture-Outside-Picture) mode.

13. The LCD monitor of claim 11, wherein the composite video signal output from the output connector is received by a recording device for recording or a second monitor for display.

14. The LCD monitor of claim 11, further comprising a first input connector receiving the video signals from the first video source, and a second input connector receiving the video signals from the second video source.
